(19) United States
(12) Patent Application Publication
(10) Pub. No.: US 2026/0004468 A1
(43) Pub. Date: Jan. 1, 2026

(54) IMAGE COMPRESSION ERROR DETECTION METHOD AND ERROR-RESISTANT IMAGE COMPRESSION METHOD AND SYSTEM

(71) Applicant: SHANGHAI JIAO TONG UNIVERSITY, Shanghai (CN)

(72) Inventors: Wenrui DAI, Shanghai (CN); Shaohui LI, Shanghai (CN); Chenglin LI, Shanghai (CN); Junni ZOU, Shanghai (CN); Hongkai XIONG, Shanghai (CN)

(73) Assignee: SHANGHAI JIAO TONG UNIVERSITY, Shanghai (CN)

(21) Appl. No.: 19/320,353

(22) Filed: Sep. 5, 2025

Related U.S. Application Data
(63) Continuation of application No. PCT/CN2024/106293, filed on Jul. 19, 2024.

(30) Foreign Application Priority Data
Jul. 28, 2023 (CN) 202310937298.8

(51) Int. Cl. G06T 9/00

(52) U.S. Cl. CPC G06T 9/002

(57) ABSTRACT

An image compression error detection method, comprising: acquiring a training image data set; extracting a first latent representation of the training image by an image compression model, wherein the first latent representation is a multi-channel latent representation for image compression; processing the first latent representation to obtain a stability measurement region for detecting an image compression error; and extracting a first latent representation of a test image, and comparing the first latent representation of the test image with the stability measurement region to obtain an image compression error detection result. This method can efficiently detect the error and corruption caused by the neural network-based image compression, and efficiently realizes stable continuous image compression, which is applicable to the actual image communication scene.

### CROSS-REFERENCE TO RELATED APPLICATIONS

This application is a continuation of International Patent Application No. PCT/CN2024/106293 with a filing date of Jul. 19, 2024, designating the United States, now pending, and further claims priority to Chinese Patent Application No. 202310937298.8 with a filing date of Jul. 28, 2023. The content of the aforementioned applications, including any intervening amendments thereto, is incorporated herein by reference.

### TECHNICAL FIELD

The present disclosure relates to the field of image processing technology, and in particular, to an image compression error detection method, and an error-resistant image compression method and system based on the image compression error detection method.

### BACKGROUND ART

In recent years, the rate-distortion performance of learnable image compression methods has far surpassed the traditional image compression methods, and has been widely concerned. Different from the traditional image compression methods, the neural network is applied in the learnable image compression model to realize the nonlinear mapping between the input image and its latent representation/latent variable, and jointly optimize the quantization, entropy coding and nonlinear mapping by the latent representation. However, the current theoretical analysis of the learnable image compression method is not sufficient. Thus, the reliability of the learnable image compression model cannot be ensured, and its application in practice is limited. Variational inference is one of the mainstream ways to explain the learnable image compression methods, which approximates the conditional a posteriori of latent representation by parameterizing the variation density, while the end-to-end optimization of encoding and decoding ends in the model is realized by the variational self-encoder. In addition to variational inference, optimal quantization and principal component analysis can also explain the superiority of the learnable image compression model. Ball é et al. published Nonlinear transform coding in IEEE Journal of Selected Topics in Signal Processing in 2021 to summarize current learnable image compression models from the perspective of non-linear transform coding and demonstrate that non-linear transform can achieve non-linear optimal quantization based on uniform quantization to achieve superior rate-distortion performance. Bhadane, et al. published Principal bit analysis: Autoencoding with schur-concave Loss in International Conference on Machine Learning in 2021 to demonstrate that for a linear self-encoder with independent scalar quantization, the principal component decomposition can achieve a minimization of the rate-distortion performance loss. However, the non-linear transformation is applied in the learnable image compression model. The principal component analysis will lead to performance degradation in practical use. Duan, et al. published Opening the black box of learned image coders in 2022 to visualize different channels represented by latent representation and propose hypotheses, but without achieving sufficient verification.

Although the methods described above provide a theoretical explanation, there is still a lack of effective and reasonable tools to understand and explain the learnable image compression model. Therefore, the theoretical explanation of the learnable image compression model is difficult to be connected with the practical application. However, the continuous image compression is very common in actual image communication scenes. Since different users will receive and send the same picture in succession, the image will be compressed in succession. However, when the same learnable image compression model is used to compress and decompress the same image repeatedly, the stability of the image cannot be guaranteed, and the reconstructed image may be corrupted. However, in existing methods, for example, Successive learned image compression: comprehensive analysis of instability in Neurocomputing published by Kim et al. in 2022 does not achieve efficient corruption detection, lacks the corresponding measurement indicators, and needs to retrain the learnable image compression model. The paper from Kim et al. proposed the use of a convolutional neural network to predict a corrupted image based on the original image and the first compressed image, indicating that the instability is predictable. However, the corrupted images used for training and testing are marked by a manually set threshold value. Thus, some corrupt images may be ignored.

### SUMMARY OF THE INVENTION

In view of the deficiencies in the prior art, the present disclosure provides an image compression error detection method and an error-resistant image compression method and system, which can efficiently realize stable continuous image compression without training.

In a first aspect of the present disclosure, there is provided an image compression error detection method comprising:
acquiring a training image data set;
extracting a first latent representation of the training image by an image compression model, wherein the first latent representation is a multi-channel latent representation for image compression;
processing the first latent representation to obtain a stability measurement region for detecting an image compression error; and
extracting a multi-channel implicit feature of a test image, namely, a first latent representation of the test image, and comparing the multi-channel latent representation with the stability measurement region to obtain an image compression error detection result.

Optionally, the stability measurement region is an admissible region for each channel of the first latent representation, and the admissible region is a numerical range of the multi-channel latent representation obtained by the image compression model for any natural image; or, the stability measurement region is an in-range region for each channel of the first latent representation, and the in-range region is a numerical range for the multi-channel latent representation obtained by the image compression model for the training image.

Optionally, the admissible region is obtained by the method of:
repeating the steps below for each channel of the first latent representation:
randomly generating a RGB three-channel image of a set size, and inputting same into an encoder of the image compression model, wherein each pixel value in the three-channel image is obtained by sampling from a normal distribution, and a numerical value is made within a range of 0 to 1 by normalization;
with the objective of minimizing an element value of the latent representation as a target, updating the input three-channel image by gradient descent, and minimizing the element value of any channel in the process of traversing the encoder output latent representation as a lower bound of the admissible region;
with the objective of maximizing the element value of the latent representation as a target, updating the input three-channel image by gradient ascent, and maximizing the element value of any channel in the process of traversing the encoder output latent representation as an upper bound of the admissible region; and
an interval range composed of an upper bound of the admissible region and a lower bound of the admissible region is the admissible region.

Optionally, the in-range region is obtained by the method of:
slidingly acquiring an image block of a set size from all the images of the training image data set, with a sliding step length being 1;
passing all the acquired image blocks through an encoder of the image compression model, and recording the element value of each channel in the latent representation output by the encoder to obtain a multi-channel latent representation;
for any c^{th} channel,
obtaining a statistical maximum value of element values of all image blocks in the c^{th} channel; and
obtaining a statistical minimum value of element values of all image blocks in the c^{th} channel;
wherein the closed interval defined by the above-mentioned statistical maximum value and statistical minimum value is an in-range region of the c^{th} channel.

Optionally, the comparing the multi-channel latent representation with the stability measurement region to obtain an image compression error detection result comprises:
if the multi-channel latent representation is in the stability measurement region, the image compression error detection result is a stable image; and
if the multi-channel latent representation exceeds the stability measurement region, the image compression error detection result is that there is image corruption and a corrupted channel is output.

According to a second aspect of the present disclosure, there is provided an error-resistant image compression method, comprising:
performing image compression error detection by the image compression error detection method to obtain the corrupted channel;
calculating a stability constraint region of a first latent representation, wherein the stability constraint region is a region for obtaining a stable reconstructed image after an image compression model is passed;
adjusting a value range of the corrupted channel according to the stability constraint region to obtain a second latent representation, and encoding the second latent representation to obtain a binary code stream; and
decoding the binary code stream to obtain a second latent representation, and passing the second latent representation through a decoder of the image compression model to obtain a reconstructed image.

Optionally, the calculating a stability constraint region of a first latent representation comprises:
for any c^{th} channel, calculating a difference between an upper bound

$${y}_{c}^{upper}$$

and a lower bound

$${y}_{c}^{lower}$$

of the in-range region as a importance measurement η_{c}:

$${η}_{c} = {y}_{c}^{upper} - {y}_{c}^{lower}$$

obtaining a maximum value ηₘₐₓ of channel importance measurement for all C channels:

$${η}_{max} = {max}_{c = 1 , … , C} {η}_{c}$$

for any c^{th} channel, calculating a stability constraint region ratio r_{c} based on the channel importance measurement η_{c} and the maximum value ηₘₐₓ of the channel importance measurement:

$${r}_{c} = \sqrt{\frac{{η}_{c}}{{η}_{max}}}$$

calculating an upper bound a_{c} and a lower bound b_{c} of the stability constraint region from a ratio r_{c} of the stability constraint region and an upper bound

$${y}_{c}^{upper}$$

and a lower bound

$${y}_{c}^{lower}$$

of an in-range region:

$${a}_{c} = \frac{1 + {r}_{c}}{2} {y}_{c}^{lower} + \frac{1 - {r}_{c}}{2} {y}_{c}^{upper}$$

$${b}_{c} = \frac{1 - {r}_{c}}{2} {y}_{c}^{lower} + \frac{1 + {r}_{c}}{2} {y}_{c}^{upper} .$$

Optionally, the adjusting a value range of the corrupted channel according to the stability constraint region to obtain a second latent representation, and encoding the second latent representation to obtain a binary code stream comprises:
detecting and adjusting all the C channels of the first latent representation, wherein for any c^{th} channel, c is a positive integer not greater than C:
the image compression error detection method outputs an in-range region and a stability constraint region of the c^{th} channel, wherein the in-range region is a real closed interval

$$[ {y}_{c}^{lower} , {y}_{c}^{upper} ] ,$$

and the stability constraint region [b_{c}, a_{c}] is a closed sub-interval of the in-range region

$$[ {y}_{c}^{lower} , {y}_{c}^{upper} ] ;$$

judging whether the values y_{c} of any element in the c^{th} channel are all in the in-range region

$$[ {y}_{c}^{lower} , {y}_{c}^{upper} ] ,$$

and if not, judging that the channel is corrupted;
if the c^{th} channel is a corrupted channel, compressing the values of the elements of the c^{th} channel to be within the stability constraint region and operating on any element y_{c}:

$${y}_{c} = min ( max ( {y}_{c} , {a}_{c} ) , {b}_{c} )$$

where max(m, n) represents taking a larger value in m and n, and min(m, n) represents taking a smaller value in m and n;
if the c^{th} channel is a corrupted channel, determining whether to adjust the c^{th} channel according to a rate-distortion loss of the compressed c^{th} channel compared with the original c^{th} channel;
if it is determined to adjust the c^{th} channel, replacing the original c^{th} channel with the compressed c^{th} channel, otherwise, keeping the original c^{th} channel unchanged; and
outputting the adjusted multi-channel latent representation as a second latent representation, and encoding the same to obtain a binary code stream.

Optionally, the, if the c^{th} channel is a corrupted channel, determining whether to adjust the c^{th} channel according to a rate-distortion loss of the compressed c^{th} channel compared with the original c^{th} channel comprises:
respectively encoding the original c^{th} channel and the compressed c^{th} channel, and recording code rates thereof as

$${R}_{c}^{1} and {R}_{c}^{2}$$

to obtain a code rate difference value

$${Δ}_{c} ( R ) = {R}_{c}^{2} - {R}_{c}^{1} ;$$

calculating an element-by-element mean square error (MSE) of the compressed c^{th} channel and the original c^{th} channel as a distortion difference value;
ranking all C channels from high to low according to the code rate difference value and the distortion difference value, and keeping previous K channels unadjusted, wherein K is a preset constant; and
determining whether the adjustment is made to the c^{th} channel to output a determination result.

According to a third aspect of the present disclosure, there is provided an error-resistant image compression system comprising:
an image compression error detection module configured for performing image compression error detection by the image compression error detection method to obtain the corrupted channel;
a stability constraint region calculation module configured for calculating a stability constraint region of a first latent representation, wherein the stability constraint region is a region for obtaining a stable reconstructed image after an image compression model is passed;
a binary code stream encoding module configured for adjusting a value range of the corrupted channel according to the stability constraint region to obtain a second latent representation, and encoding the second latent representation to obtain a binary code stream; and
a decoding module configured for decoding the binary code stream to obtain a second latent representation, and passing the second latent representation through a decoder of the image compression model to obtain a reconstructed image.

Compared to the prior art, the embodiments of the present disclosure have at least one of the following beneficial effects.

According to the image compression error detection method in an embodiment of the present disclosure, a first latent representation of a training image is extracted by an image compression model to obtain a stability measurement region for detecting an image compression error by processing the first latent representation, so that the image compression error detection can be accurately realized and the method can be applied to the error resistance of continuous image compression.

According to the image compression error detection method in an embodiment of the present disclosure, an admissible region or an in-range region is adopted as a stability measurement region, and a statistical value can be directly output based on an encoder output feature of the image compression model (a maximum value and a minimum value obtained by the encoder traversing the whole training set). In addition to the encoder and decoder of the image compression model, there is no need for additional computational resources such as neural networks.

The error-resistant image compression method and system in the embodiment of the present disclosure can significantly improve the stability of the neural network-based image coding model, and can ensure the image quality without generating errors in continuous compression.

The error-resistant image compression method and system in the embodiment of the present disclosure can be directly applied to the pre-trained image coding model without re-training, which cannot be realized by the existing methods.

The embodiments of the present disclosure are based on the above-mentioned error-resistant image compression method and system, which can realize stable and continuous compression on natural images with different resolutions acquired under different scenes. The present disclosure has great practical application value, and especially in practical image communication, is applied to the image compression method based on neural network.

### BRIEF DESCRIPTION OF THE DRAWINGS

Other features, objects and advantages of the disclosure will become more apparent from a reading of the detailed description of a non-limiting embodiment with reference to the following drawings.

FIG. 1 is a flow diagram of an image compression error detection method according to an embodiment of the present disclosure.

FIG. 2 is a flow diagram of obtaining an admissible region for each channel of the coding side output latent representation on a channel-by-channel basis in an embodiment of the present disclosure.

FIG. 3 is a flow diagram of an in-range region for each channel of the coding side output latent representation in an embodiment of the present disclosure.

FIG. 4 shows a method for comparing the results of image compression error detection in an embodiment of the present disclosure.

FIG. 5 is a flow diagram of an error-resistant image compression method in an embodiment of the present disclosure.

FIG. 6 is a flow diagram for calculating a stability constraint region for a first latent representation in an embodiment of the present disclosure.

FIG. 7 is a flow diagram for adjusting corrupted channel values based on the stability constraint region in an embodiment of the present disclosure.

FIG. 8 is a flow diagram for determining whether a channel for the latent representation is required to be adjusted in an embodiment of the present disclosure.

FIG. 9 is a diagram illustrating the implementation of the error-resistant image compression method in an embodiment of the present disclosure.

### DETAILED DESCRIPTION OF PREFERRED EMBODIMENTS

Hereinafter, the present disclosure will be described in detail with reference to specific embodiments. The following embodiments will aid those skilled in the art in further understanding of the present disclosure and are not intended to limit the disclosure in any way. It should be noted that several variations and modifications can be made by a person skilled in the art without departing from the inventive concept. These are all within the scope of the present disclosure.

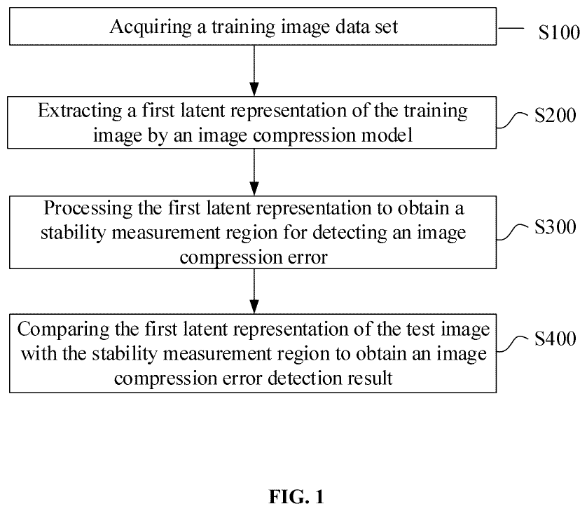

FIG. 1 is a flow diagram of an image compression error detection method according to an embodiment of the present disclosure.

With reference to FIG. 1, the image compression error detection method in the present embodiment comprises the steps of:

S100, acquiring a training image data set.

In this step, the training image can be any natural image, and a plurality of training images constitute a training image data set. The vimeo90k data set may be used in this embodiment as the training image data set.

S200, extracting a first latent representation of the training image by an image compression model, wherein the first latent representation is a multi-channel latent representation for image compression.

In this step, the image compression model can be any image compression model in the prior art, for example, an image encoding model based on a multi-layer neural network. The multi-layer neural network can be obtained by alternately superposing a convolution layer and a non-linear activation layer, or by alternately superposing a self-attention layer and a non-linear activation layer. Of course, other image coding models of network structures are also possible, and the present disclosure can be applied to image coding models of different kinds of networks.

As a preferable example, the following image compression model can be used in this embodiment. The encoder is composed of four convolution layers, the channel numbers of the four convolution layers are 128, 128, 128 and 192, respectively, and the first three convolution layers are all followed by a non-linear unit GDN (generalized divisive normalization). The convolution kernel size of each convolution layer is 0, and the convolution step size is 2. Thus, when the input image size is H×W×3 (a three-channel image), the resulting first latent representation represents a size

$$\frac{H}{16} \times \frac{W}{16} \times 192 .$$

S300, processing the first latent representation to obtain a stability measurement region for detecting an image compression error.

In this step, the stability measurement region may be an admissible region or an in-range region.

Specifically, the stability measurement region is an admissible region for each channel of the first latent representation, and the admissible region is a numerical range of the multi-channel latent representation obtained by the image compression model for any natural image.

The stability measurement region is an in-range region for each channel of the first latent representation, and the in-range region is a numerical range for the multi-channel latent representation obtained by the image compression model for the training image.

When applied to image compression, the admissible region or the in-range region can be used as a measurement to measure the stability of the multi-channel latent representation of the test image obtained by the image compression model.

S400, extracting a first latent representation of a test image, and comparing the first latent representation of the test image with the stability measurement region to obtain an image compression error detection result.

In this step, the test image is a compressed image of a specific image, and whether the image has a corrupted result is detected by extracting a multi-channel latent feature, i. e., a first latent representation, of the test image, and comparing the same with the above-mentioned admissible region or in-range region. Herein, a multi-channel implicit feature of a test image is extracted by an image compression model, and the structure of the image compression model is the same as or corresponds to the image compression model of S200.

The image compression error detection method according to the above-mentioned embodiments of the present disclosure can efficiently detect the quality error and corruption caused by the neural network-based image compression, and efficiently realize stable continuous image compression, which is applicable to the actual image communication scene. It does not contain any neural network other than the image compression model, and can be used in various types of pre-training network.

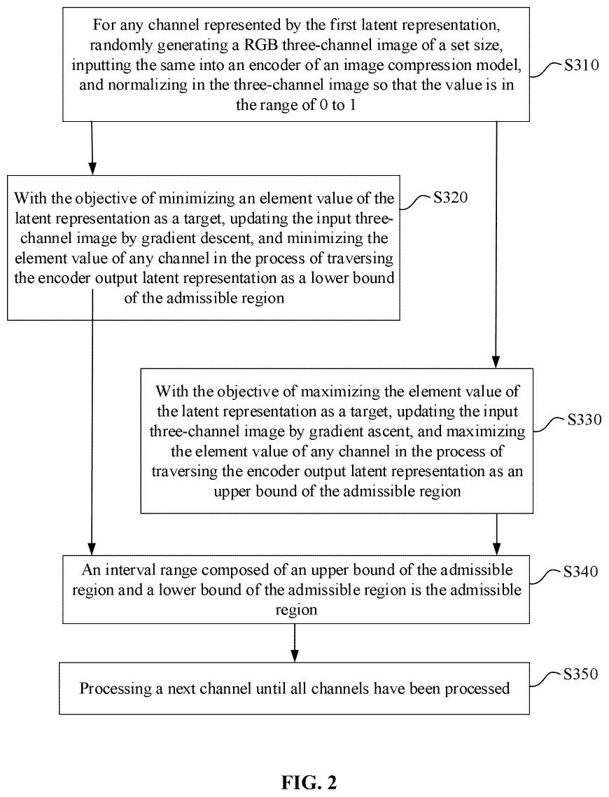

FIG. 2 is a flow diagram of obtaining an admissible region for each channel of the first latent representation on a channel-by-channel basis in an embodiment of the present disclosure. Referring to FIG. 2, the procedure for the admissible region acquisition in a preferred embodiment of the present disclosure is illustrated, and in this pre-selected embodiment, the admissible region acquisition may specifically include the steps of:
repeating the steps below for each channel of the first latent representation:

S310, for any channel represented by the first latent representation, randomly generating a RGB three-channel image of a set size, inputting the same into an encoder of an image compression model, and normalizing in the three-channel image so that the value is in the range of 0 to 1.

In this step, the RGB three-channel image of a set size are randomly generated, wherein the image size can be set according to actual needs. In the present embodiment, the three-channel input image is randomly generated to have a size of 16×16, but in other embodiments, the three-channel input image may have other sizes.

In this step, in the process of random generation of three-channel image, each pixel value of image is sampled from normal distribution, and it can be normalized by the Sigmoid function to make the value within the range of 0 to 1. Of course, in other embodiments, other normalization methods may be used.

S320, with the objective of minimizing an element value of the latent representation as a target, updating the input three-channel image by gradient descent, and minimizing the element value of any channel in the process of traversing the encoder output latent representation as a lower bound of the admissible region.

S330, with the objective of maximizing the element value of the latent representation as a target, updating the input three-channel image by gradient ascent, and maximizing the element value of any channel in the process of traversing the encoder output latent representation as an upper bound of the admissible region.

Step S340, an interval range composed of an upper bound of the admissible region and a lower bound of the admissible region is the admissible region.

In this step, the admissible region describes possible numerical ranges of the first latent representation obtained by the image compression model for any image. Therefore, the multi-channel latent features falling outside the range of values can be considered as unstable for the corresponding test images thereof.

The method for calculating the admissible region in the above-mentioned embodiments of the present disclosure does not need a data set support, and can estimate the stability region of the multi-channel implicit feature under the premise of only having an image compression model.

S350, processing a next channel until all 192 channels have been processed.

This embodiment adopts the admissible region obtained by the above-mentioned steps to detect an image compression error. If the first latent representation of the test image indicates that the admissible region is exceeded, it indicates that the difference between the input image and the training image is large, and there is a possibility of image corruption. The relationship between the first latent representation obtained by the image compression model of the input image and the admissible region can thus be used to determine whether the input image is a corrupted image.

In the above-described embodiment of FIG. 2, the specific image size is not limited to the above description, but may be any other size, and may be determined by the network structure of the image compression model to be used.

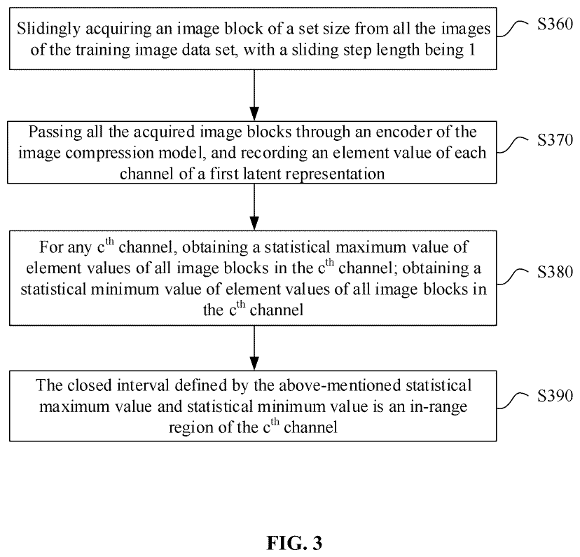

FIG. 3 is a flow diagram of an in-range region for each channel of the first latent representation in an embodiment of the present disclosure. Referring to FIG. 3, a procedure for the in-range region acquisition in a preferred embodiment is illustrated. In this preferred embodiment, the in-range region acquisition may in particular comprise the steps of:

S360, slidingly acquiring an image block of a set size from all the images of the training image data set, with a sliding step length being 1.

In the present embodiment, the image block of the acquired set size may be the acquired 16×16 image block, but in other embodiments, the image block of the acquired set size may be another size.

S370, passing all the acquired image blocks through an encoder of the image compression model, and recording an element value of each channel of a first latent representation.

S380, for any c(1≤c≤192)^{th} channel, obtaining a statistical maximum value of element values of all image blocks in the c^{th} channel; and obtaining a statistical minimum value of element values of all image blocks in the c^{th} channel.

S390, the closed interval defined by the above-mentioned statistical maximum value and statistical minimum value is an in-range region of the c^{th} channel.

In this step, the in-range region describes a possible numerical range represented by a first latent representation obtained by a training image through an image compression model, and a multi-channel implicit feature falling outside the numerical range. A corresponding test image has a distribution of different from that of the training image, and is considered to be an image different from a natural image, that is to say, unstable image content exists.

The method of calculating the in-range region in the above-described embodiments of the present disclosure employs a training data set that traverses the various possibilities of image input and is therefore more accurate with respect to admissible regions.

In this embodiment, the in-range region obtained by the above-mentioned steps is used to detect an image compression error. If the multi-channel implicit feature of the test image exceeds the in-range region, it indicates that the difference between the input image and the training image is large, and there is a possibility of image corruption. Thus, the relationship between the multi-channel latent representation of the input image and the in-range region obtained by the image compression model can be used to determine whether the input image is a corrupted image.

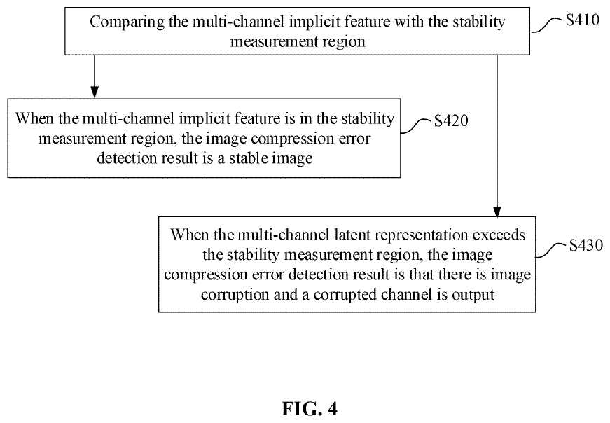

FIG. 4 is a method for obtaining the image compression error detection results by comparison in an embodiment of the present disclosure, wherein the image compression error detection results are obtained by comparing the first latent representation of the test image with the stability measurement region. Specifically, in this preferred embodiment, it is possible to include

S410, extracting a first latent representation of the test image, and comparing the first latent representation with the stability measurement region; and the stability measurement region is any one of an admissible region or an in-range region.

The first latent representation (multi-channel implicit feature) of the extracted test image is obtained by the image compression model. The image compression model used is consistent with the image compression model used for “using the image compression model to extract the first latent representation of the training image” in S200. The first latent representation of the image is a tensor.

S420, if the first latent representation of the test image is in the stability measurement region, the image compression error detection result is a stable image.

S430, if the first latent representation of the test image indicates that the stability measurement region is exceeded, the image compression error detection result is that there is image corruption, and a corrupted channel is output.

The image compression error detection method in the above-mentioned embodiments of the present disclosure has great practical application value, and especially in practical image communication, is applied to the image compression method based on neural network. In the actual image communication scene, the images are transmitted between different users, which inevitably requires the image to be compressed repeatedly, i. e., the encoding and decoding process is repeated many times. The current neural network-based image coding model generates serious reconstruction distortion with the increase of repetition times in the practical application scene. In order to solve this problem, the present disclosure further provides an error-resistant image compression method and system. Based on the corrupted image detected by the image compression error detection method in the above-mentioned embodiment, the following image compression method is further used for compression. By means of the error-resistant image compression method and system, the quality of image reconstruction in such practical scenes can be greatly improved. At the same time, compared with the widely used image compression standards such as JPEG and JPEG 2000, the bit rate is significantly reduced.

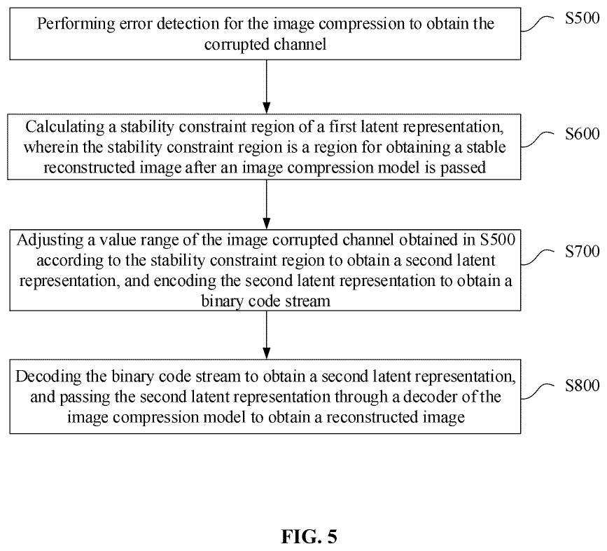

In particular, the technical features of the error-resistant image compression method and system are described in detail below with reference to the drawings of FIGS. 5-8.

FIG. 5 is a flow diagram of an error-resistant image compression method in an embodiment of the present disclosure.

With reference to FIG. 5, an error-resistant image compression method is provided in the present embodiment, which specifically comprises the steps of:

S500, performing error detection on image compression to obtain an image corrupted channel; wherein the error detection on image compression can be performed using the image compression error detection method as described in S100-S400;

S600, calculating a stability constraint region of a first latent representation, wherein the stability constraint region is a region for obtaining a stable reconstructed image after an image compression model is passed; and the first latent representation is the same as the image compression model in S200 in the image compression error detection method described;

S700, adjusting a value range of the image corrupted channel obtained in S500 according to the stability constraint region to obtain a second latent representation, and encoding the second latent representation to obtain a binary code stream; and

S800, decoding the binary code stream to obtain a second latent representation, and passing the second latent representation through a decoder of the image compression model to obtain a reconstructed image.

The error-resistant image compression method provided in this embodiment can significantly improve the stability of the neural network-based image coding model by using the stability constraint region to adjust the image corrupted channel for the detected corrupted channel, without generating errors in the continuous compression, and ensure the image quality. As described in the above steps, the image compression method can be directly applied to the pre-trained image coding model without the need for retraining.

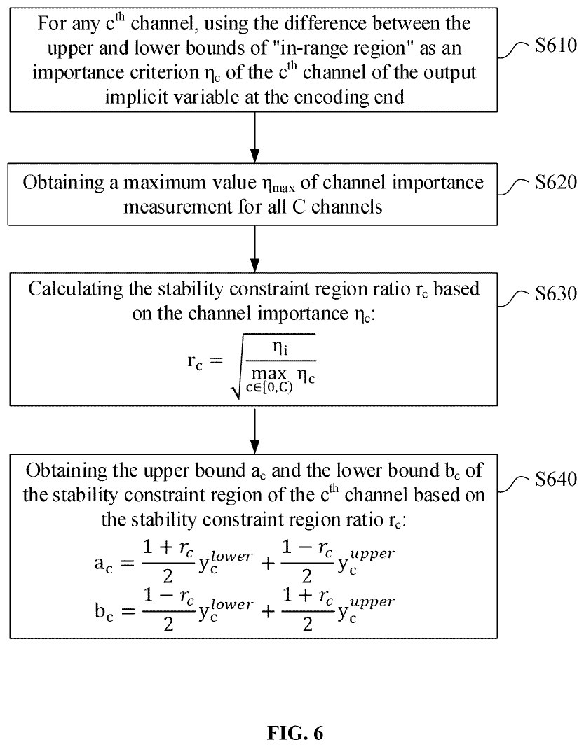

FIG. 6 is a flow diagram for calculating a stability constraint region for a first latent representation in an embodiment of the present disclosure.

With reference to FIG. 6, in this preferred embodiment, the calculation of the stability constraint region of the first latent representation may particularly comprise the steps of:

S610, for any c^{th} channel, calculating a difference between an upper bound

$${y}_{c}^{upper}$$

and a lower bound

$${y}_{c}^{lower}$$

of the in-range region as a importance measurement η_{c}:

$${η}_{c} = {y}_{c}^{upper} - {y}_{c}^{lower}$$

S620, obtaining a maximum value ηₘₐₓ of the channel importance measurement of all 192 channels of the first latent representation:

$${η}_{max} = {max}_{c = 1 , ⋯ , 192} {η}_{c}$$

S630, for any c^{th} channel, calculating a stability constraint region ratio r_{c} based on the channel importance measurement η_{c} and the maximum value ηₘₐₓ of the channel importance measurement:

$${r}_{c} = \sqrt{\frac{{η}_{c}}{{η}_{max}}}$$

S640, calculating an upper bound a_{c} and a lower bound b_{c} of the stability constraint region from a ratio r_{c} of the stability constraint region and an upper bound

$${y}_{c}^{upper}$$

and a lower bound

$${y}_{c}^{lower}$$

of an in-range region:

$${a}_{c} = \frac{1 + {r}_{c}}{2} {y}_{c}^{lower} + \frac{1 - {r}_{c}}{2} {y}_{c}^{upper}$$

$${b}_{c} = \frac{1 - {r}_{c}}{2} {y}_{c}^{lower} + \frac{1 + {r}_{c}}{2} {y}_{c}^{upper} .$$

In this step, the stability constraint region is contracted from the in-range region, and the first latent representation falling within the region of values is assumed to be numerically closer to the mean value of the training image and is therefore considered to be stable. By constraining the unstable first latent representation to the region, the stability of the reconstructed image can be improved.

In the above-mentioned embodiments of the present disclosure, the method for calculating the stability constraint region only needs simple numerical calculation, does not need an additional neural network, and has a small calculation amount and is easy to deploy compared with the existing methods.

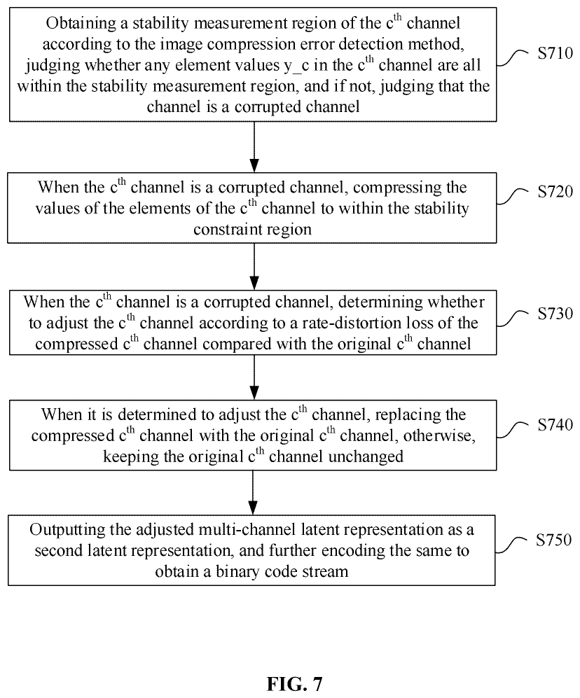

FIG. 7 illustrates a method for adjusting corrupted channel values based on the stability constraint region in an embodiment of the present disclosure.

With reference to FIG. 7, in the preferred embodiment, in order to better realize the error resistance performance in image compression, for S700, adjusting the value range of the obtained image corrupted channel according to the stability constraint area may specifically comprise the steps of:

S710, obtaining a stability measurement region of the c^{th} channel according to the image compression error detection method, judging whether any element values y_{c} in the c^{th} channel are all within the stability measurement region, and if not, judging that the channel is a corrupted channel.

In this step, the stability measurement region may be the above-mentioned in-range region

$$[ {y}_{c}^{lower} , {y}_{c}^{upper} ]$$

or the above-mentioned stability constraint region [b_{c}, a_{c}], and the specific calculation method may be described with reference to the above-mentioned embodiment.

S720, if the c^{th} channel is a corrupted channel, compressing the values of the elements of the c^{th} channel to be within the stability constraint region and operating on any element y_{c}:

$${y}_{c} = min ( max ( {y}_{c} , {a}_{c} ) , {b}_{c} )$$

where max(m, n) represents taking a larger value in m and n, and min(m, n) represents taking a smaller value in m and n;

S730, if the c^{th} channel is a corrupted channel, determining whether to adjust the c^{th} channel according to a rate-distortion loss of the compressed c^{th} channel compared with the original c^{th} channel;

S740, if it is determined to adjust the c^{th} channel, replacing the original c^{th} channel with the compressed c^{th} channel, otherwise, keeping the original c^{th} channel unchanged; and

S750, outputting the adjusted multi-channel latent representation as a second latent representation, and further encoding the same to obtain a binary code stream

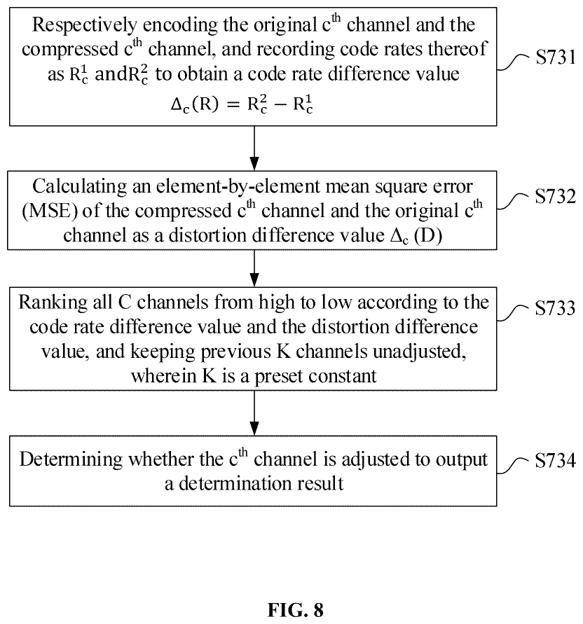

FIG. 8 is a flow diagram for determining whether a channel for the latent representation is required to be adjusted in an embodiment of the present disclosure, including a method for determining whether to adjust the channel of the latent representation based on the rate-distortion loss after compression.

Referring to FIG. 8, for S730 described above, whether to adjust the c^{th} channel may be determined based on the post-compression rate-distortion loss. Specifically, in a preferred embodiment, it is possible to perform the steps of:

S731, respectively encoding the original c^{th} channel and the compressed c^{th} channel, and recording code rates thereof as

$${R}_{c}^{1} and {R}_{c}^{2}$$

to obtain a code rate difference value

$${Δ}_{c} ( R ) = {R}_{c}^{2} - {R}_{c}^{1} ;$$

S732, calculating an element-by-element mean square error (MSE) of the compressed c^{th} channel and the original c^{th} channel as a distortion difference value Δ_{c}(D);

S733, ranking all 192 channels from high to low according to the code rate difference value and the distortion difference value, and keeping previous K channels unadjusted, wherein K is a preset constant.

In this step, K/2 channels are filtered by the code rate difference value and the distortion difference value from high to low, respectively, to obtain a total number of K channels.

In this step, K can be selected according to the requirements of practical applications. For example, K can be 20.

S734, judging whether the channel belongs to the above-mentioned K channels, and outputting a judgement result. If it belongs to the K^{th} channel, it is not adjusted; otherwise, the adjustment is required.

The above-mentioned method of judging whether the channel needs to be adjusted or can effectively prevent the degradation of the expression ability of the image compression model caused by the unreasonable channel adjustment (namely, stability constraint) in the implementation process, and ensure the reconstruction quality in continuous compression.

Based on the same technical concept, in another embodiment of the present disclosure, there is provided an error-resistant image compression system, comprising:
an image compression error detection module configured for performing image compression error detection by the image compression error detection method shown in FIG. 1 to obtain the corrupted channel;
a stability constraint region calculation module configured for calculating a stability constraint region of a first latent representation, wherein the stability constraint region is a region for obtaining a stable reconstructed image after an image compression model is passed;
a binary code stream encoding module configured for adjusting a value range of the corrupted channel according to the stability constraint region to obtain a second latent representation, and encoding the second latent representation to obtain a binary code stream; and
a decoding module configured for decoding the binary code stream to obtain a second latent representation, and passing the second latent representation through a decoder of the image compression model to obtain a reconstructed image.

The concrete implementation method of the above-mentioned modules in the present embodiment can be referred to the implementation process of the steps in implementing the error-resistant image compression method, which will not be described in detail herein.

The error-resistant image compression system in this embodiment can be used to realize the error-resistant image compression method, which can efficiently detect the quality error and corruption caused by the neural network-based image compression, and efficiently realize stable continuous image compression, which is applicable to the actual image communication scene.

### Examples of Application

The error-resistant image compression method of the above-described embodiment of the present disclosure is used for untrained mitigation of image corruption caused by successive compressions of images.

The scene of continuous image compression is described as follows. An original picture pic 1 is sent after being compressed by a user 1 end based on an end-to-end image compression model. After receiving, a user 2 end restores and obtains the pic 2 by the same image compression model, and then the user 2 end compresses and sends the restored picture pic 2 by the same image compression model. After receiving, a user 3 repeats the same operation as that of the user 2 and sends same to the next user end. By analogy, the same image is compressed and reconstructed several times based on the same end-to-end image compression model in the process of sending and receiving at different user ends, and the scene can be referred to as “image continuous compression”.

In this application scenario,
firstly, the method in the above-mentioned embodiment is used to obtain an in-range region, and it is judged whether the pic 1 is corrupted by judging whether the multi-channel latent representation f1 obtained by the pic 1 passing through the image compression model is in the “in-range region”. If it is corrupted, a stable representation f′1 is obtained by adjusting f1 to the “stability constraint region”.

The above-mentioned adjusted image is restored via the above-mentioned image compression model to obtain the pic 2. After that, the pic 2 is taken as the input image to judge whether the picture is corrupted again, and the obtained multi-channel latent representation is adjusted to be in the “stability constraint region”.

According to the above-mentioned operation, the process is repeated, i. e., the continuous image compression is achieved.

### Implementation Effect

In the above embodiment, with the error-resistant image compression method provided by the present disclosure, the model is pre-trained based on 8 hyper-a priori network floating-point numbers of different qualities provided by compressAI. The reconstructed image has the highest distortion compared with the original image when the quality is 1, and the reconstructed image has the lowest distortion compared with the original image when the quality is 8. A 16*16 input image is acquired in combination with the Vimeo 90kdata set to acquire an in-range region for each channel of the coding side output latent representation, and perform continuous compression corruption detection in combination with the Tecnick data set.

TABLE 1
Test results

| | | Paper detection | Detection |
|---|---|---|---|
| Model | Number of | results from | results of the |
| quality | reference images | Kim et al. | present disclosure |
| 1 | 3 | 0 | 2 |
| 2 | 2 | 0 | 2 |
| 3 | 6 | 4 | 6 |
| 4 | 14 | 6 | 14 |
| 5 | 29 | 19 | 28 |
| 6 | 82 | 10 | 75 |
| 7 | 21 | 17 | 21 |
| 8 | 45 | 41 | 45 |

In the above-described embodiment, the channel corruption detection method provided by the present disclosure is used to detect the amount of corruption after 50 consecutive compressions of 100 images in the Tecnick data set, and is compared with the detection method proposed in the paper by Kim et al. An image having a PSNR attenuation of more than 0.2 dB after 20 to 50 consecutive compressions and an image having a visual irregular pattern after 50 consecutive compressions are marked as corrupted images as reference images. The test results are given in Table 1, and the method of the present disclosure can detect more corrupted images than the paper by Kim et al.

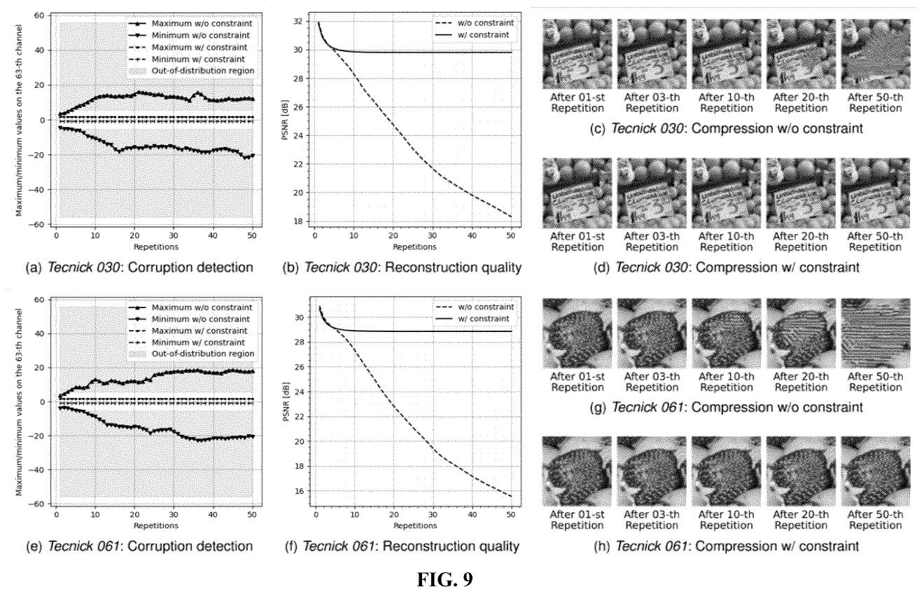

In the above-mentioned embodiment, each picture of the Tecnick data set is successively compressed 50 times, and the error-resistant image compression method provided by the present disclosure is used to adjust the coding end output latent representation after each compression to detect a corrupted channel. FIG. 9 shows the results of successive compressions of the 30th and 61st images in the Tecnick data set, based on a pre-trained hyper-prior model with a quality level of 4. As shown in FIG. 9, with the error-resistant image compression method provided by the present disclosure, the latent representation of the encoder end remains in the “in-range region” at all times during continuous compression, while the PSNR fading is mitigated. In addition, with the error-resistant image compression method provided by the present disclosure, the visual quality of the reconstructed image after successive compressions is significantly improved.

Therefore, the present disclosure can realize stable and continuous compression on the natural images with different resolutions collected under different scenes, and has great practical application value, and especially in practical image communication, is applied to the image compression method based on neural network.

It will be appreciated by those skilled in the art that embodiments of the present disclosure may be provided as a method, a system, or a computer program product. Accordingly, the present disclosure may take the form of an entirely hardware embodiment, an entirely software embodiment or an embodiment combining software and hardware aspects.

The present disclosure is described with reference to flowchart illustrations and/or block diagrams of methods, device (systems), and computer program products according to embodiments of the disclosure. It will be understood that each flow and/or block of the flowchart and/or block diagrams, and combinations of flows and/or blocks in the flowcharts and/or block diagrams, can be implemented by computer program instructions. These computer program instructions may be provided to a general purpose computer, a special purpose computer, an embedded processor, or a processor of other programmable data processing device to produce a machine, such that the instructions, which are executed via the processor of the computer or other programmable data processing device, create means for implementing the functions specified in the flow or flows of the flowchart and/or the block or blocks of the block diagram.

These computer program instructions may also be stored in a computer-readable memory that can direct a computer or other programmable data processing device to function in a particular manner, such that the instructions stored in the computer-readable memory produce an article of manufacture including instruction means which implement the function specified in the flow or flows of the flowchart and/or the block or blocks of the block diagram.

These computer program instructions may also be loaded onto a computer or other programmable data processing devices to cause a series of operational steps to be performed on the computer or other programmable devices to produce a computer implemented process, such that the instructions executed on the computer or other programmable devices provide steps for implementing the functions specified in the flowchart flow or flows and/or block diagram block or blocks.

Although preferred embodiments of the present disclosure have been described, it should be understood that the disclosure is not limited to the specific embodiments described above, and that additional variations and modifications to these embodiments will occur to those skilled in the art once the basic inventive concept is known. Therefore, it is intended that the appended claims be interpreted as including the preferred embodiments and all alterations and modifications that fall within the scope of the embodiments of the disclosure. The above-mentioned preferred features of the disclosure can be used in any combination, provided that they do not conflict with each other.

What is claimed is:

1. An error detection method for image compression, comprising:
acquiring a training image data set;
extracting a first latent representation of the training image by an image compression model, wherein the first latent representation is a multi-channel latent representation for image compression;
processing the first latent representation to obtain a stability measurement region for detecting an image compression error; and
extracting a first latent representation of a test image, and comparing the first latent representation of the test image with the stability measurement region to obtain an image compression error detection result;
wherein the stability measurement region is an admissible region for each channel of the first latent representation, and the admissible region is a numerical range of the multi-channel latent representation obtained by the image compression model for any natural image; and
the admissible region is obtained by a method comprising:
repeating the steps below for each channel of the first latent representation:
randomly generating a RGB three-channel image of a set size, and inputting same into an encoder of the image compression model, wherein each pixel value in the three-channel image is obtained by sampling from a normal distribution, and a numerical value is made within a range of 0 to 1 by normalization;
with the objective of minimizing an element value of the latent representation as a target, updating the input three-channel image by gradient descent, and minimizing the element value of any channel in the process of traversing the encoder output latent representation as a lower bound of the admissible region;
with the objective of maximizing the element value of the latent representation as a target, updating the input three-channel image by gradient ascent, and maximizing the element value of any channel in the process of traversing the encoder output latent representation as an upper bound of the admissible region; and
an interval range composed of an upper bound of the admissible region and a lower bound of the admissible region is the admissible region.

2. The image compression error detection method according to claim 1, wherein the comparing the first latent representation of the test image with the stability measurement region to obtain an image compression error detection result comprises the following steps:
when the multi-channel latent representation is in the stability measurement region, an image compression error detection result is a stable image; and
when the multi-channel latent representation exceeds the stability measurement region, the image compression error detection result is that there is image corruption and a corrupted channel is output.

3. An error-resistant image compression method, comprising:
performing image compression error detection by the error detection method according to claim 1 to obtain a corrupted channel;
calculating a stability constraint region of a first latent representation, wherein the stability constraint region is a region for obtaining a stable reconstructed image after an image compression model is passed;
adjusting a value range of the corrupted channel according to the stability constraint region to obtain a second latent representation, and encoding the second latent representation to obtain a binary code stream; and
decoding the binary code stream to obtain a second latent representation, and passing the second latent representation through a decoder of the image compression model to obtain a reconstructed image.

4. The error-resistant image compression method according to claim 3, wherein the calculating a stability constraint region of a first latent representation comprises:
for any c^{th} channel, calculating a difference between an upper bound
$${y}_{c}^{upper}$$
and a lower bound
$${y}_{c}^{lower}$$
of the in-range region as a importance measurement η_{c}:
$${η}_{c} = {y}_{c}^{upper} - {y}_{c}^{lower}$$
obtaining a maximum value ηₘₐₓ of channel importance measurement for all C channels:
$${η}_{max} = {max}_{c = 1 , … , C} {η}_{c}$$
for any c^{th} channel, calculating a stability constraint region ratio r_{c} based on the channel importance measurement η_{c} and the maximum value ηₘₐₓ of the channel importance measurement:
$${r}_{c} = \sqrt{\frac{{η}_{c}}{{η}_{max}}}$$
calculating an upper bound a_{c} and a lower bound b_{c} of the stability constraint region from a ratio r_{c} of the stability constraint region and an upper bound
$${y}_{c}^{upper}$$
and a lower bound
$${y}_{c}^{lower}$$
of an in-range region:
$${a}_{c} = \frac{1 + {r}_{c}}{2} {y}_{c}^{lower} + \frac{1 - {r}_{c}}{2} {y}_{c}^{upper}$$
$${b}_{c} = \frac{1 - {r}_{c}}{2} {y}_{c}^{lower} + \frac{1 + {r}_{c}}{2} {y}_{c}^{upper} .$$

5. The error-resistant image compression method according to claim 4, wherein the adjusting a value range of the corrupted channel according to the stability constraint region to obtain a second latent representation, and encoding the second latent representation to obtain a binary code stream comprises:
detecting and adjusting all the C channels of the first latent representation, wherein for any c^{th} channel, c is a positive integer not greater than C;
the image compression error detection method outputs an in-range region and a stability constraint region of the c^{th} channel, wherein the in-range region is a real closed interval
$$[ {y}_{c}^{lower} , {y}_{c}^{upper} ] ,$$
and the stability constraint region [b_{c}, a_{c}] is a closed sub-interval of the in-range region
$$[ {y}_{c}^{lower} , {y}_{c}^{upper} ] ;$$
judging whether the values y_{c} of any element in the c^{th} channel are all in the in-range region
$$[ {y}_{c}^{lower} , {y}_{c}^{upper} ] ,$$
and if not, judging that the channel is corrupted;
when the c^{th} channel is a corrupted channel, compressing the values of the elements of the c^{th} channel to be within the stability constraint region and operating on any element y_{c}:
$${y}_{c} = min ( max ( {y}_{c} , {a}_{c} ) , {b}_{c} )$$
where max(m, n) represents taking a larger value in m and n, and min(m, n) represents taking a smaller value in m and n;
when the c^{th} channel is a corrupted channel, determining whether to adjust the c^{th} channel according to a rate-distortion loss of the compressed c^{th} channel compared with the original c^{th} channel;
when it is determined to adjust the c^{th} channel, replacing the original c^{th} channel with the compressed c^{th} channel, otherwise, keeping the original c^{th} channel unchanged; and
outputting the adjusted multi-channel latent representation as a second latent representation, and encoding the same to obtain a binary code stream.

6. The error-resistant image compression method according to claim 5, wherein the, when the c^{th} channel is a corrupted channel, determining whether to adjust the c^{th} channel according to a rate-distortion loss of the compressed c^{th} channel compared with the original c^{th} channel comprises:
respectively encoding the original c^{th} channel and the compressed c^{th} channel, and recording code rates thereof as
$${R}_{c}^{1} and {R}_{c}^{2}$$
to obtain a code rate difference value
$${Δ}_{c} ( R ) = {R}_{c}^{2} - {R}_{c}^{1} ;$$
calculating an element-by-element mean square error (MSE) of the compressed c^{th} channel and the original c^{th} channel as a distortion difference value;
ranking all C channels from high to low according to the code rate difference value and the distortion difference value, and keeping previous K channels unadjusted, wherein K is a preset constant; and
determining whether the adjustment is made to the c^{th} channel to output a determination result.

7. An error-resistant image compression system, comprising:
an error detection module configured for performing error detection by the error detection method according to claim 1 to obtain a corrupted channel;
a stability constraint region calculation module configured for calculating a stability constraint region of a first latent representation, wherein the stability constraint region is a region for obtaining a stable reconstructed image after an image compression model is passed;
a binary code stream encoding module configured for adjusting a value range of the corrupted channel according to the stability constraint region to obtain a second latent representation, and encoding the second latent representation to obtain a binary code stream; and
a decoding module configured for decoding the binary code stream to obtain a second latent representation, and passing the second latent representation through a decoder of the image compression model to obtain a reconstructed image.
